(19) United States
(12) Patent Application Publication
(10) Pub. No.: US 2018/0109080 A1
(43) Pub. Date: Apr. 19, 2018

(54) SCREW GUARD

(71) Applicant: Warren King, Farnham, VA (US)

(72) Inventor: Warren King, Farnham, VA (US)

(21) Appl. No.: 15/785,666

(22) Filed: Oct. 17, 2017

Related U.S. Application Data
(60) Provisional application No. 62/409,209, filed on Oct. 17, 2016.

(51) Int. Cl. H02B 1/30

(52) U.S. Cl. CPC H02B 1/30

(57) ABSTRACT

A screw guard. The screw guard includes an elongated body. The elongated body includes an inner surface, an outer surface, a first bottom edge, a second bottom edge, and a front edge. The first bottom edge and the second bottom edge are disposed along a length of the elongated body. A slot is formed by the inner surface, and an entrance into the slot is formed by the front edge. An adhesive is attached along the first bottom edge and the second bottom edge.

### CROSS-REFERENCE TO RELATED APPLICATION

This application claims the benefit of priority of U.S. provisional application No. 62/409,209, filed Oct. 17, 2016, the contents of which are herein incorporated by reference.

### BACKGROUND OF THE INVENTION

The present invention relates to a screw guard and, more particularly, to a screw guard for preventing pinched wires in an electrical panel.

An electrical panel is a component of an electricity supply system that divides an electrical power feed into subsidiary circuits, while providing a protective fuse or circuit breaker for each circuit in a common enclosure. Often the wires in an electrical panel or in data enclosures get pinched between the panel/enclosure cover screw and the panel or enclosure itself. This may cause electrical hazards/explosions or short circuits in the wire. Currently, methods used to prevent pinched wires include bending or tying wires away from cover screws, which is not very effective.

As can be seen, there is a need for a screw guard and method of using the screw guard to prevent pinched wires.

### SUMMARY OF THE INVENTION

In one aspect of the present invention, a screw guard comprises: an elongated body comprising an inner surface, an outer surface, a first bottom edge, a second bottom edge, and a front edge, wherein the first bottom edge and the second bottom edge are disposed along a length of the elongated body, a slot is formed by the inner surface, and an entrance into the slot is formed by the front edge; and an adhesive attached along the first bottom edge and the second bottom edge.

In another aspect of the present invention, a method of preventing wire contact with panel cover screws comprises the steps of: providing a screw guard comprising an inner surface, an outer surface, a first bottom edge, a second bottom edge, and a front edge, wherein a slot is formed by the inner surface and an entrance into the slot is formed by the front edge; adhering the first bottom edge and the second bottom edge of the screw guard to an inside of a panel box so that the entrance of the screw guard is adjacent to and aligned with a screw opening of a panel box flange; aligning a screw opening of a panel cover with the screw opening of the panel box flange; and driving a screw through the screw opening of the panel cover, the screw opening of the panel box flange and the entrance into the slot of the screw guard. These and other features, aspects and advantages of the present invention will become better understood with reference to the following drawings, description and claims.

### BRIEF DESCRIPTION OF THE DRAWINGS

FIG. 1 is a top perspective view of an embodiment of the present invention;

FIG. 2 is a bottom perspective view of an embodiment of the present invention;

FIG. 3 is an exploded view of an embodiment of the present invention;

FIG. 4 is a section view of the present invention, taken along line 4-4 in FIG. 1;

FIG. 5 is a perspective view of an embodiment of the present invention, shown in use;

FIG. 6 is a section view of the present invention, taken along line 6-6 in FIG. 5;

FIG. 7 is a perspective view of an embodiment of the present invention illustrating installation into a box with wires;

FIG. 8 is a top perspective view of an embodiment of the present invention;

FIG. 9 is a bottom perspective view of an embodiment of the present invention;

FIG. 10 is an exploded view of an embodiment of the present invention;

FIG. 11 is a section view of the present invention taken along line 11-11 in FIG. 8; and

FIG. 12 is a perspective view of an embodiment of the present invention illustrating installation into a box with wires.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a screw guard that protects wires in an electrical or data panel from screws that connect a panel cover or shield to the enclosure. The present invention surrounds the panel box or enclosure cover screw to prevent wires in panel or enclosures to be compromised when a cover screw is installed.

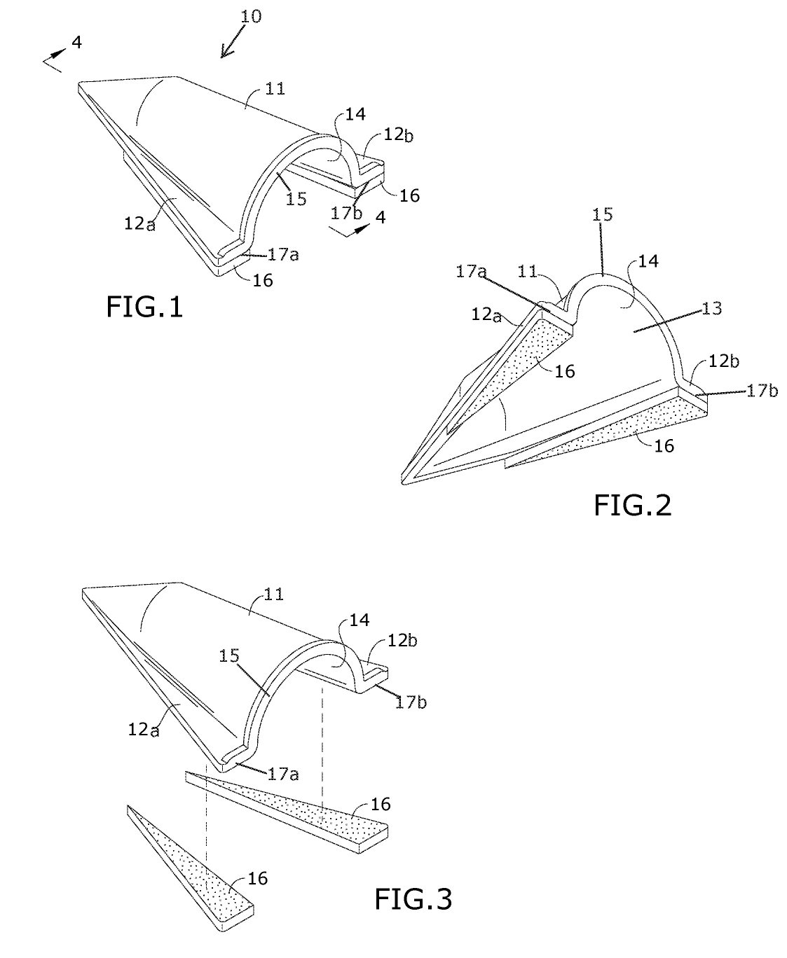

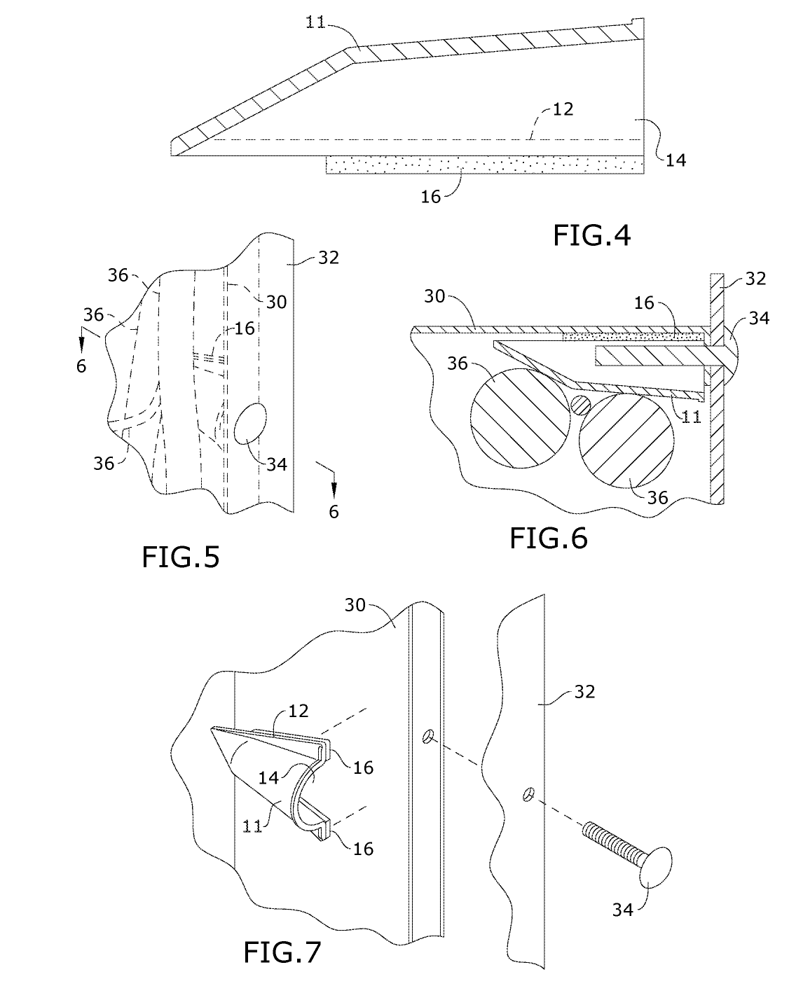

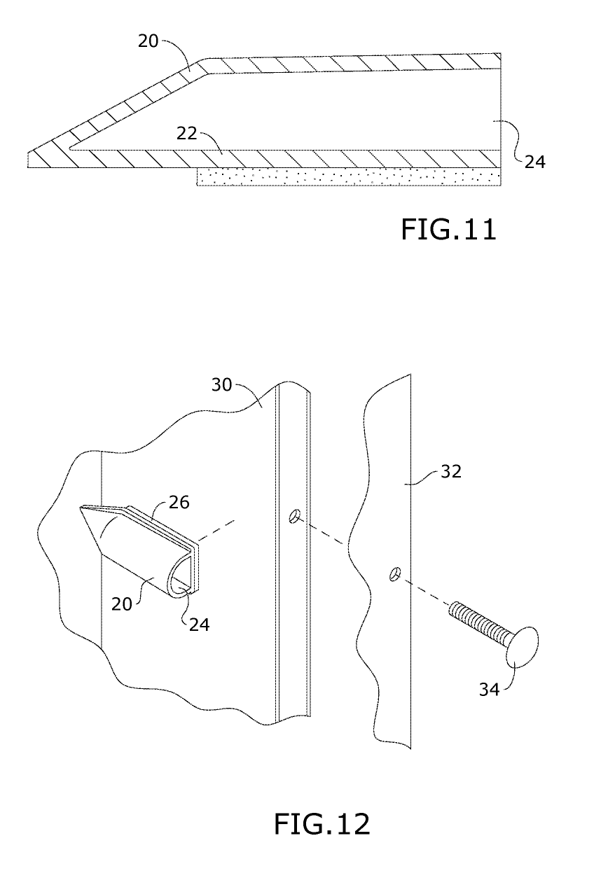

Referring to FIGS. 1 through 12, the present invention includes a screw guard. The screw guard includes an elongated body 10. The elongated body 10 includes an inner surface 13, an outer surface 11, a first bottom edge 17a, a second bottom edge 17b, and a front edge 15. The first bottom edge 17a and the second bottom edge 17b are disposed along a length of the elongated body 10. A slot 14 is formed by the inner surface 13, and an entrance into the slot 13 is formed by the front edge 15. An adhesive 16 is attached along the first bottom edge 17a and the second bottom edge 17b.

The elongated body 10 may be formed of a polymer, such as plastic, silicone and the like. The adhesive 16 may be a glue, a double sided tape, a spray on adhesive and the like.

In certain embodiments, the front edge 15 of the elongated body is substantially perpendicular to the first bottom edge 17a and the second bottom edge 17b of the elongated body 10. The first bottom edge 17a and the second bottom edge 17b of the elongated body are coplanar and therefore may lay flat against a surface in which the bottom edges 17a, 17b are adhered to.

In certain embodiments, the elongated body 10 may include a semi-cylindrical shape. A semi-cylindrical shape is the shape of a cylinder cut in half along its length. In certain embodiments, the elongated body 10 may include a semi-frusto conical shape. A semi-frusto conical shape is the shape of a cone cut at the top and cut in half along its length. In certain embodiments, the elongated body may include a rear end having a semi-conical shape. A semi-conical shape is the shape of a cone cut in half along its length. In such embodiments, the elongated body 10 may taper and end at a point.

As illustrated in FIGS. 1 through 7, the present invention may include an elongated body 10 with a first wing 12a laterally extending from the first bottom edge 17a and a second wing 12b laterally extending from the second bottom edge 17b. Each of the first and second wings 12a, 12b may extend perpendicular relative to the first and second bottom edges 17a, 17b respectively. The first and second wings 12a, 12b may include flat and coplanar bottom surfaces. The adhesive 16 may be attached along a length of the first wing 12a and the second wing 12b.

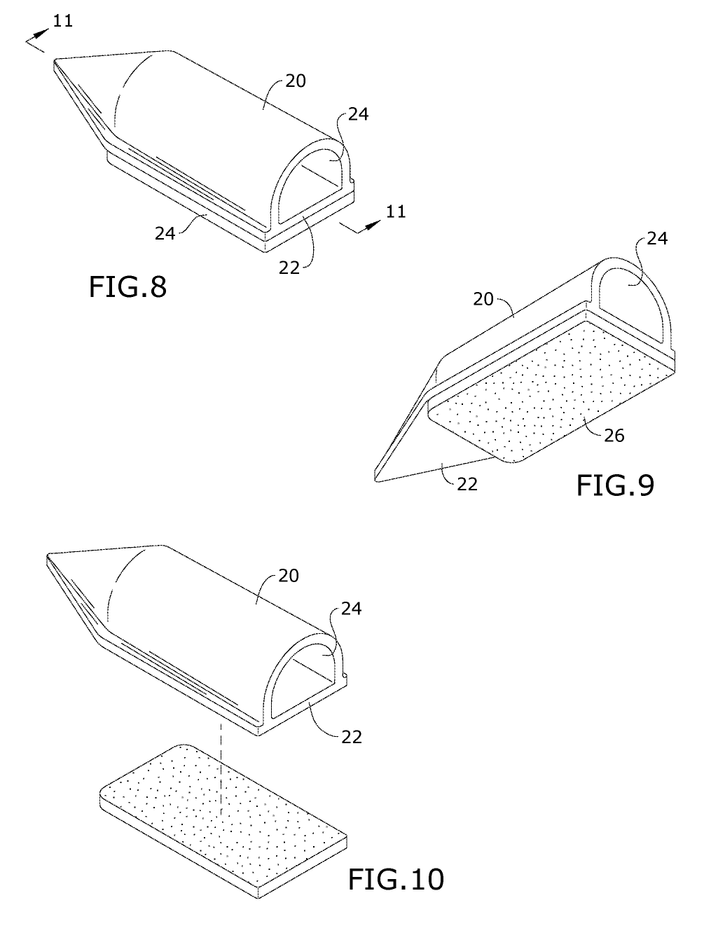

As illustrated in FIGS. 8 through 12, the present invention may include an alternate embodiment. An elongated body 20 is similar to the elongated body described above having a slot 24 and further including a bottom wall 22. The adhesive 26 may be attached to a bottom surface of the bottom wall 22. The bottom surface of the bottom wall 22 may be planar and lay flat on a surface in which it is adhered to.

A method of preventing wire contact with panel cover screws may include the following steps. The screw guard described above is provided. The first bottom edge 17a and the second bottom edge 17b of the screw guard are adhered to an inside of a panel box 30 so that the entrance of the screw guard is adjacent to and aligned with a screw opening of a panel box flange. A screw opening of a panel cover 32 is aligned with the screw opening of the panel box flange. A screw 34 is driven through the screw opening of the panel cover 32, the screw opening of the panel box flange and the entrance into the slot 14 of the screw guard. As illustrated in the Figures, the screw guard protects the screw 34 from pinching the wires 36 within the panel box 30.

It should be understood, of course, that the foregoing relates to exemplary embodiments of the invention and that modifications may be made without departing from the spirit and scope of the invention as set forth in the following claims.

What is claimed is:

1. A screw guard comprising:
an elongated body comprising an inner surface, an outer surface, a first bottom edge, a second bottom edge, and a front edge, wherein the first bottom edge and the second bottom edge are disposed along a length of the elongated body, a slot is formed by the inner surface, and an entrance into the slot is formed by the front edge; and
an adhesive attached along the first bottom edge and the second bottom edge.

2. The screw guard of claim 1, wherein the front edge of the elongated body is substantially perpendicular to the first bottom edge and the second bottom edge of the elongated body.

3. The screw guard of claim 1, wherein the elongated body comprises a semi-cylindrical shape.

4. The screw guard of claim 1, wherein the elongated body comprises a semi-frusto conical shape.

5. The screw guard of claim 4, wherein the elongated body comprises a rear end comprising a semi-conical shape.

6. The screw guard of claim 1, wherein the first bottom edge and the second bottom edge of the elongated body are coplanar.

7. The screw guard of claim 1, wherein the elongated body further comprises a first wing laterally extending from the first bottom edge and a second wing laterally extending from the second bottom edge, wherein the adhesive is attached along the first wing and the second wing.

8. The screw guard of claim 1, wherein the elongated body further comprises a bottom wall extending from the first bottom edge to the second bottom edge, wherein the adhesive is attached along a bottom surface of the bottom wall.

9. The screw guard of claim 1, wherein the elongated body is made of a polymer.

10. A method of preventing wire contact with panel cover screws comprising the steps of:
providing a screw guard comprising an inner surface, an outer surface, a first bottom edge, a second bottom edge, and a front edge, wherein a slot is formed by the inner surface and an entrance into the slot is formed by the front edge;
adhering the first bottom edge and the second bottom edge of the screw guard to an inside of a panel box so that the entrance of the screw guard is adjacent to and aligned with a screw opening of a panel box flange;
aligning a screw opening of a panel cover with the screw opening of the panel box flange; and
driving a screw through the screw opening of the panel cover, the screw opening of the panel box flange and the entrance into the slot of the screw guard.

11. The method of claim 10, wherein the front edge of the screw guard is substantially perpendicular to the first bottom edge and the second bottom edge of the elongated body.

12. The method of claim 10, wherein the screw guard comprises a semi-cylindrical shape.

13. The method of claim 10, wherein the screw guard comprises a semi-frusto conical shape.

14. The method of claim 13, wherein the screw guard comprises a rear end comprising a semi-conical shape.

15. The method of claim 10, wherein the first bottom edge and the second bottom edge of the screw guard are coplanar.

16. The method of claim 10, wherein the screw guard further comprises a first wing laterally extending from the first bottom edge and a second wing laterally extending from the second bottom edge.

17. The method of claim 16, further comprising the step of: adhering the first wing and the second wing of the screw guard to the inside of the panel box.

18. The method of claim 10, wherein the screw guard further comprises a bottom wall extending from the first bottom edge to the second bottom edge.

19. The method of claim 18, further comprising the step of: adhering the bottom surface of the bottom wall to the inside of the panel box.

20. The method of claim 10, wherein the screw guard is made of a polymer.
